(19) United States
(12) Patent Application Publication
(10) Pub. No.: US 2022/0048322 A1
(43) Pub. Date: Feb. 17, 2022

(54) IMPROVED FURNITURE

(71) Applicant: Susanna DE LUCA, MASSA (MS) (IT)

(72) Inventor: Susanna DE LUCA, MASSA (MS) (IT)

(21) Appl. No.: 17/299,474

(22) PCT Filed: Aug. 12, 2019
(86) PCT No.: PCT/IB2019/056830

§ 371 Date: Jun. 3, 2021

(30) Foreign Application Priority Data
Dec. 4, 2018 (IT) 102018000010800

(51) Int. Cl. B60B 33/08; B60B 33/00

(52) U.S. Cl. CPC B60B 33/08; B60B 33/0005

(57) ABSTRACT

A piece of furniture suitable to rest on a contact surface and including a main structure defining a lower surface facing the contact surface; rolling elements, each including a sphere rolling on the contact surface; and an anchoring body for anchoring the rolling elements to the main structure.

The present invention relates to furniture of the type specified in the preamble of the first claim.

As is known, furniture is a fundamental part of the furnishing of a home or of other premises (for example offices) and is mainly used as a container for equipment, clothes, linen, documents or other objects. Some examples of furniture are, for example, chests, cupboards and wardrobes.

They are made of quality materials (usually wood) or cheaper and usually polymeric materials.

The described prior art has a few major drawbacks.

In particular, the known furniture, due to the materials used as well as the objects usually placed therein, is so heavy as to be almost impossible to move.

This drawback results in a high amount of dirt which accumulates, for example, beneath it or between it and a wall and is extremely difficult to remove due to the difficulty in accessing and cleaning these spaces.

Moreover, the difficulty in moving the furniture makes it difficult and hard to change its arrangement and therefore adapt the room to particular possible needs, such as moving house or gathering the furniture in a limited area in order to have a large free area.

In this context, the technical task underlying the present invention is to devise furniture which is capable of substantially obviating at least some of the above-mentioned drawbacks.

Within the scope of said technical task, a major object of the invention is to obtain furniture which can be easily moved.

The technical task and the specified objects are achieved by means of furniture as claimed in the appended claim 1. Examples of preferred embodiments are described in the dependent claims.

The features and advantages of the invention will be clarified in the following detailed description of preferred embodiments of the invention, with reference to the accompanying drawings, in which:

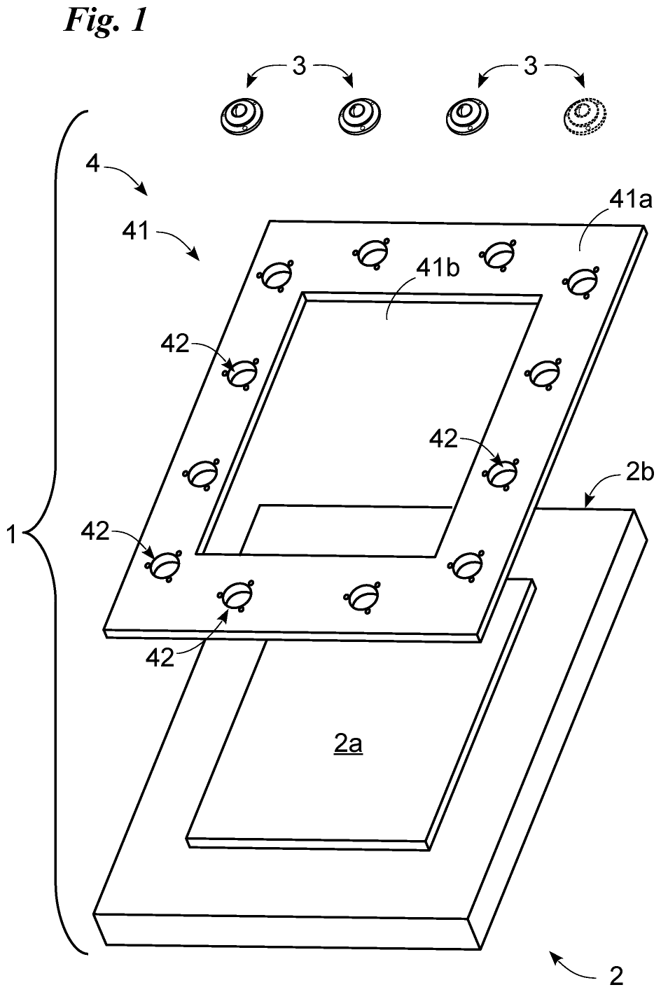

FIG. 1 shows a bottom exploded view of the furniture according to the invention;

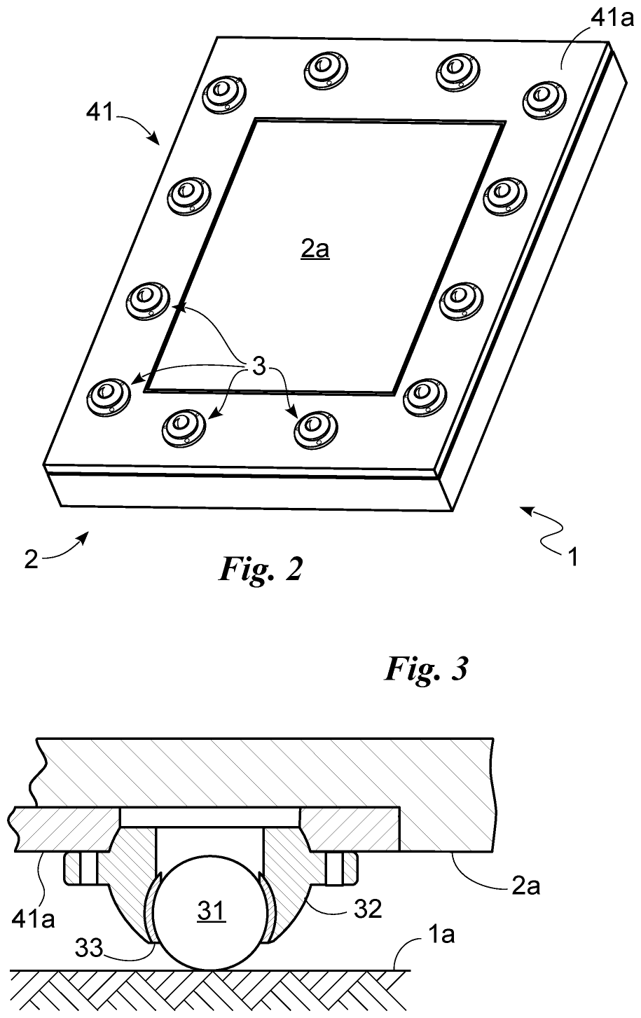

FIG. 2 shows a second bottom view of the furniture; and

FIG. 3 shows a sectional component of the furniture according to the invention.

Herein, the measures, values, shapes and geometric references (such as perpendicularity and parallelism), when used with words like “about” or other similar terms such as “approximately” or “substantially”, are to be understood as except for measurement errors or inaccuracies due to production and/or manufacturing errors and, above all, except for a slight divergence from the value, measure, shape or geometric reference with which it is associated. For example, these terms, if associated with a value, preferably indicate a divergence of not more than 10% from said value.

Furthermore, when used, terms such as “first”, “second”, “higher”, “lower”, “main” and “secondary” do not necessarily identify an order, a priority relationship or a relative position, but can simply be used to distinguish more clearly the different components from each other.

The measurements and data provided herein are to be considered as performed in ICAO International Standard Atmosphere (ISO 2533), unless otherwise indicated.

With reference to the Figures, the furniture according to the invention is indicated as a whole by the numeral 1.

The furniture 1 is suitable to rest on a contact surface 1a usually identifiable as a floor.

It is used for storing items such as, for example, clothes, bags, shoes, appliances and/or tableware such as plates, bowls, cups, cutlery and glasses.

The furniture 1 is therefore not identifiable as a chair or other similar piece of furniture having a sitting surface, i.e. a surface specifically/mainly designed for sitting on it.

The furniture 1 comprises a main structure 2 defining at least one storage volume and a lower surface 2a facing, in use, the contact surface 1a of the furniture 1.

The main structure 2 can be substantially that of a piece of furniture, for example of a known type, such as a cupboard or a wardrobe.

Preferably, the lower surface and therefore the main structure 2 do not come into contact with the contact surface 1a when the furniture 1 is in use.

The furniture 1 comprises a plurality of rolling elements 3 suitable to come into contact with the contact surface 1 a when the furniture 1 is in use; and an anchoring body 4 for anchoring the rolling elements 3 to the main structure 2.

Preferably, the rolling elements 3 are located along the perimeter of the lower surface 2a, but preferably spaced from said perimeter, as in FIG. 2, so as not to be visible when the furniture 1 is in use. They are thus placed parallel to the perimeter of the lower surface 2a, ensuring a correct distribution of the weight of the furniture 1 on the rolling elements 3.

Alternatively or additionally, one or more rolling elements 3 can be placed near the barycentre of the furniture 1, i.e. in the central part of the lower surface 2a.

Each rolling element 3 comprises a sphere 31 rolling on the contact surface 1a; and a base 32 suitable to support the sphere 31.

The sphere 31 is constrained to the base 32 so as not to move with respect to it.

The sphere 31 is free to rotate idly with respect to the base 32 about at least one rotation axis, in detail two rotation axes, and preferably three rotation axes.

Said rotation axes are perpendicular to each other.

Conveniently, a rolling element 3 comprises a bushing 33, or similar element, interposed between the sphere 31 and the base 32 and suitable to minimize the friction of the sphere 31 with respect to the rest of the rolling element 3.

Each rolling element 3, to be precise the base 32, can be integrally fastened to the anchoring body 4, leaving the sphere 31 free to rotate. The base 32 can be detachably fastened to the anchoring body 4 by means of, for example, screws or interlocking.

The anchoring body 4 can be fastened to the main structure 2 at the lower surface 2a, standing between the structure 2 and the rolling elements 3 which, in use, stand between the contact surface 1a and the lower surface 2a.

It can be fastened to the lower surface 2a by interlocking.

The anchoring body 4 can comprise a plate 41 suitable to be fastened to the main structure 2; and at least one seat 42 formed in the plate 41 and suitable to partially accommodate the rolling elements 3. Preferably, it comprises a seat 42 for the rolling element 3.

The plate 41 is substantially flat.

The plate 41 defines a lower face 41a facing, in use, the contact surface 1a of the furniture 1 and can comprise an opening 41b suitable to engage with the main structure 2, arranging the lower face 41a flush with the lower surface 2a, as shown in FIG. 2.

For this purpose, the main structure 2 comprises a countersinking 2b of the lower surface 2a substantially counter-shaped to the plate 41 and therefore to the anchoring body 4.

The opening 41b is suitably in the centre of the plate 41.

The plate 41 can be metallic.

In some cases, the furniture 1 can comprise one or more stops suitable to prevent unwanted movements of the furniture 1.

The stops can comprise a wedge suitable to fit between the contact surface 1a of the furniture 1 and at least one of the lower face 41a and the lower surface 2a.

Alternatively, they can be identified as telescopic elements suitably integral with the plate 41 and suitable to abut against the contact surface 1a of the furniture 1, thus preventing the furniture 1 from moving through friction or spacing of the rolling elements away from the contact surface 1a.

The operation of the furniture 1, previously described in structural terms, is as follows.

The furniture 1, in use, only has the rolling elements 3 and in particular the spheres 31 in contact with the contact surface 1a.

When it is desired to move the furniture, the user will simply have to push with a force exceeding the force due to the rolling friction of the spheres. Consequently, the furniture 1, thanks to the capability of the spheres 31 to rotate idly with respect to three distinct axes perpendicular to each other, is free to easily follow the force irrespective of the direction in which it is desired to move the furniture 1.

The furniture 1 according to the invention achieves important advantages.

In fact, unlike the known furniture, the furniture 1, by using spheres 31, is easily movable irrespective of the weight of the furniture itself and of any objects placed on it.

Since the furniture 1 can be easily moved, the dust or other dirt which accumulates, for example, under the furniture itself can be easily removed, and the arrangement of the furniture can be changed simply and without effort, changing the appearance of the room according to a change in taste or special needs.

The invention is susceptible of variations falling within the scope of the inventive concept as defined by the claims. In this context all the details may be replaced with equivalent elements and the materials, shapes and dimensions may be as desired.

1. Furniture suitable to rest on a contact surface and comprising:
a main structure defining at least one storage volume for items and a lower surface for facing this contact surface;
a plurality of rolling elements, each rolling element comprising a sphere for rolling on the contact surface;
an anchoring body for anchoring said rolling elements to said main structure at said lower surface to allow said rolling elements to stand between the contact surface and said lower surface.

2. The furniture according to claim 1, in which said rolling element comprises a base suitable to support said sphere allowing said sphere exclusively to rotate idly with respect to said base about at least one rotation axis.

3. The furniture according to claim 2, in which said sphere rotates idly with respect to said base around three distinct rotation axes.

4. The furniture according to claim 1, in which said anchoring body comprises a plate suitable to be fastened to said main structure; and at least one seat formed in said plate and suitable to partially accommodate said rolling elements.

5. The furniture according to claim 4, in which said anchoring body comprises a seat for each of said rolling elements.

6. The furniture according to claim 4, in which said plate defines a lower face facing, in use, said contact surface and comprises an opening suitable to engage with said main structure arranging said lower face flush with said lower surface.

7. The furniture according to claim 6, in which said main structure comprises a countersinking of said lower surface substantially counter-shaped to said plate.

8. The furniture according to claim 5, in which said plate defines a lower face facing, in use, said contact surface and comprises an opening suitable to engage with said main structure arranging said lower face flush with said lower surface.

9. The furniture according to claim 8, in which said main structure comprises a countersinking of said lower surface substantially counter-shaped to said plate.
